(19) United States
(12) Patent Application Publication
(10) Pub. No.: US 2004/0034564 A1
(43) Pub. Date: Feb. 19, 2004

(54) Wireless network system and method for managing a restaurant and enhancing patron service

(76) Inventor: Hsaio-Feng D. Liu, Jacksonville, FL (US)

Correspondence Address: Mark J. Young, McGuireWoods LLP, Suite 3300, 50 North Laura Street, Jacksonville, FL, 32202, US

(21) Appl. No.: 10/223,052

(22) Filed: Aug. 16, 2002

(51) Int. Cl. G06F 17/60

(52) U.S. Cl. 705/15

(57) ABSTRACT

A wireless network system and method for managing a restaurant and enhancing patron service includes a transaction processing terminal and a payment module; an on-site guest terminal for on-site input of patron information; a management terminal with a management reporting module for generating management reports and a messaging module for producing, managing and delivering messages to patrons; a plurality of portable service personnel terminals for taking orders; a kitchen terminal for managing orders; a server computer terminal for performing computer server functions; a live menu module for generating live menus; and one or more networks to which each terminal and module is communicatively connected.

### FIELD OF THE INVENTION

This invention relates generally to restaurants and more particularly to a wireless network system and method for managing a restaurant and enhancing patron service.

### BACKGROUND

The benefits of automation are well known in the restaurant industry. In recent years, various computer implemented tools have emerged to facilitate restaurant operations, including seating, order fulfillment and billing, inventory management and generation of management reports. While these tools provide substantial advantages over their manual predecessors, they still suffer several shortcomings.

First, existing restaurant management systems are not designed to function with conventional personal digital assistants. Use of such ubiquitous computing devices provides several advantages, including cost savings attributed to use of commercial off-the-shelf equipment, upgradability, expandability and true portability. These devices are small enough to be carried in a pocket or on a belt by servers throughout their entire workshift. They are also efficient enough to use without recharging for an extended period of time. In addition, such devices may include more than enough computing power, memory and wireless communications capabilities to perform desired operations.

Second, existing systems do not accommodate customer input. Instead, they rely heavily on input by restaurant personnel according to customer requests. Thus, a patron may have to stand in line to communicate a seating request to a hostess. When seated, the patron may have to wait for a server to take an order. Then, when finished dining, the patron may have to wait for the server to accept a method of payment, process the payment and provide a receipt. These tasks could be streamlined significantly if patrons are able to directly input any or all of the required information (e.g., a reservation, a check-in for seating, a menu order, credit card information for payment, etc. . . . ) before arriving at the restaurant or while waiting to be seated, and if certain information (e.g., credit card information for payment) is maintained for future visits.

Third, existing restaurant management systems accommodate only conventional impersonal menus. A “live menu” capability would allow routine updating of menu items, and space for messages such as announcements (e.g., “Congratulations Name”, “Happy Birthday Name” or “Happy Anniversary Names”) and advertisements. The message space may be provided as a courtesy to patrons or for a fee.

Fourth, existing systems do not use historical patron information to enhance services. Rather, existing systems tend to focus on the transaction at hand and maintenance of anonymous historical data (i.e., without patron identification) for conventional management reports. A system designed to provide enhanced services may maintain patron information and keep track of a patron's prior orders to facilitate future ordering. Thus, a patron may request an order that is “the same as last time”, or may request that her steak be cooked “slightly longer than last to time.” Additionally, such historical information may be used for purposes of updating menus with the most popular items, and targeted advertising.

Another deficiency with existing systems which relates to the use of patron-specific historical information is the lack of marketing functions. While marketing is an integral part of the successful operation of any restaurant business, it has been overlooked by restaurant management systems. A capability for broadcasting marketing messages targeted to certain patrons, such as text messages by email or recorded voice messages by telephone, could increase the level of repeat business.

Yet another shortcoming of existing systems is a lack of patron communication means. Customers appreciate gentle reminders, thank you messages and special invitations. Performing such tasks manually, in a conventional manner, may be too time consuming and expensive for a small business with a limited budget or for a high-volume business. Yet existing restaurant management systems do not automate or facilitate these important tasks so that they are performed routinely, consistently and efficiently.

Still another deficiency with existing systems is limited payment and receipt functionality. Conventional full-service dining restaurants do not accommodate credit card payment transaction processing at the table, PIN authenticated debit card processing at the table, payment based on pre-stored credit card information, or electronic receipt delivery to Patrons.

Thus, a restaurant management system is needed that functions with conventional personal digital assistants, accommodates customer input, provides a live menu capability, maintains and utilizes historical patron information to enhance services, enables targeted marketing by broadcast email or recorded voice messages, provides enhanced payment and receipt functions and improves communications with patrons.

### SUMMARY

It is therefore an object of the present invention to provide a restaurant management system that utilizes conventional personal digital assistants for input by servers and output to servers.

It is another object of the present invention to provide a restaurant management system that accommodates customer input to facilitate rendering services.

It is also another object of the invention to provide a restaurant management system that provides a live menu function capable of producing updated menus with patron messages and advertisements.

It is yet another object of the invention to provide a restaurant management system that maintains and effectively utilizes historical patron information to enhance services.

It is a further object of the invention to provide a restaurant management system that enables targeted marketing by generating email or recorded voice messages for broadcast, via email, facsimile transmission or telephone, to patrons who meet specified target criteria.

It is yet a further object of the invention to provide a restaurant management system that enables enhanced payment and receipt functions, including, credit and debit card processing at a table and formatted receipt delivery via email.

It is still a further object of the invention to provide a restaurant management system that enables improved communications with patrons via automated reminders, thank you messages and targeted invitations.

To achieve these and other objects, a system in accordance with an exemplary embodiment of the present invention includes a transaction processing terminal and a payment module; an on-site guest terminal for on-site input of patron information; a management terminal with a management reporting module for generating management reports and a messaging module for producing, managing and delivering messages to patrons; a plurality of service personnel terminals for taking orders using an ordering (or order taking) module and for communicating with said payment module; a kitchen terminal for managing orders; a server computer terminal for performing computer server functions; and one or more networks to which each terminal and module is communicatively connected.

### BRIEF DESCRIPTION OF THE DRAWINGS

The foregoing and other objects, features and advantages of the present invention will become better understood with reference to the following description, appended claims, and accompanying drawings, where:

FIG. 1 is a flowchart that conceptually depicts an exemplary reservation process for performance using a reservation module in accordance with a preferred implementation of the present invention;

FIG. 2 is a flowchart that conceptually depicts table exemplary assignment and release processes for performance using table assignment and release modules in accordance with a preferred implementation of the present invention;

FIG. 3 is a flowchart that conceptually depicts an exemplary payment process for performance using a payment module in accordance with a preferred implementation of the present invention;

FIG. 4 is a flowchart that conceptually depicts an exemplary ordering process and a kitchen process for performance using an ordering module and kitchen module in accordance with a preferred implementation of the present invention; and

FIG. 5 is a flowchart that conceptually depicts an exemplary reporting process for performance using a reporting module in accordance with an implementation of the present invention; and

FIG. 6 is a flowchart that conceptually depicts an exemplary message process for performance using a message module in accordance with an implementation of the present invention; and

FIG. 7 is a flowchart that conceptually depicts an exemplary live menu process for performance using a live menu module in accordance with an implementation of the present invention; and

FIG. 8 is a high-level flowchart that conceptually depicts an exemplary methodology in accordance with an implementation of the present invention; and

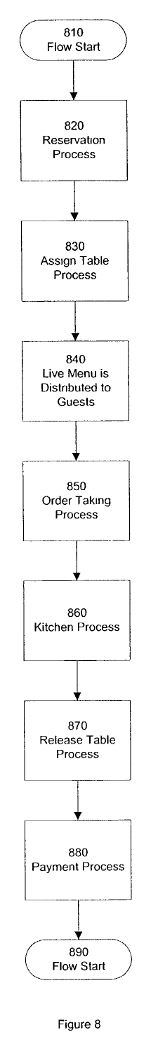

FIG. 9 is a diagram that conceptually depicts a wireless network system for managing a restaurant and enhancing patron service in accordance with an implementation of the present invention; and

FIG. 10 is a diagram that conceptually depicts an exemplary computer for use as a terminal in accordance with an implementation of the present invention.

### DETAILED DESCRIPTION

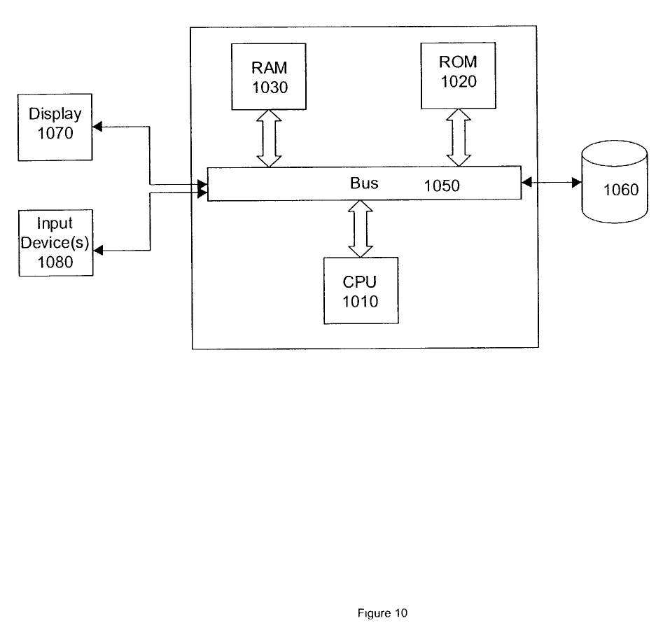

A system in accordance with an exemplary embodiment of the present invention includes a plurality of terminals communicatively connected to one or more networks. Referring to FIG. 10, each terminal preferably a computer system, preferably having a bus 1050 for communicating information, a central processing unit (CPU) 1010, a read only memory (ROM) 1020 and a random access memory (RAM) 1030. Additionally, a mass storage device 160, a display device 170 and an input device 180 may be provided. The storage device may include a hard disk, CD-ROM drive, DVD drive, tape drive, memory (e.g., RAM, ROM, CompactFlash RAM, PCMCIA RAM) and/or other storage equipment. The input device may include a communications link and/or other means for inputting data such as a keyboard, touch sensitive screen, a pointing device and the like. These elements are typically included in most computer systems and the aforementioned terminal is intended to represent a broad category of computer systems capable of supporting a method for managing a restaurant and enhancing patron service in accordance with the present invention. Of course, the terminals may include fewer, different and/or additional elements, provided each is capable, when programmed, of performing determined functions in accordance with the present invention. The terminals may take various different forms. Some terminals may be portable handheld units, others may be personal computers, some others may be dumb terminals, another may be a server. Additionally, terminals may share hardware (e.g., a remote hard disk for storage). Furthermore, it is understood by those of skill in the art that the present invention may be implemented using terminals comprised of digital signal processors (DSP), application-specific integrated circuits (ASIC), discrete gate logic, or other hardware, firmware, or any conventional programmable software module and a microprocessor. Software modules could reside in ROM, RAM, flash memory, registers, or any other form of readable and writable storage medium known in the art.

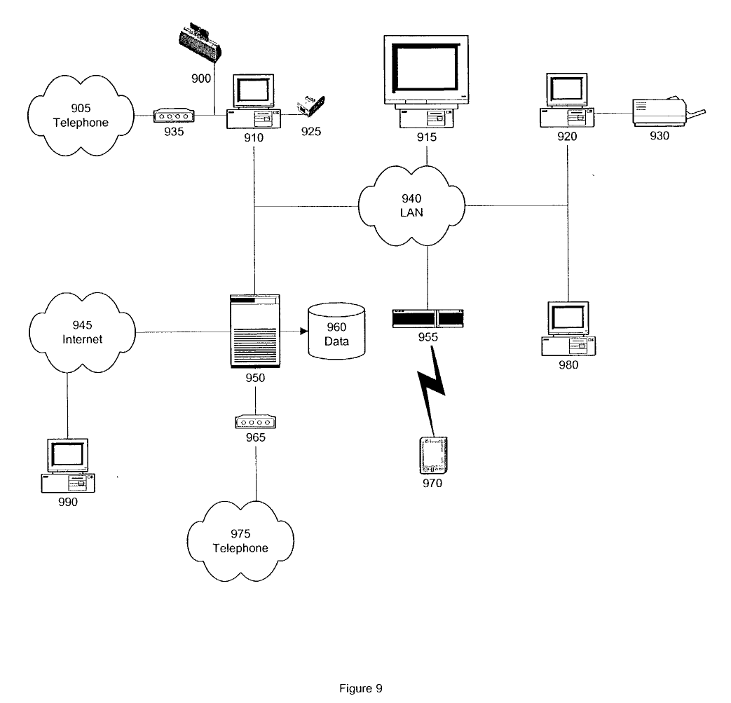

Referring now to FIG. 9, a system in accordance with an exemplary embodiment of the present invention includes a transaction processing terminal 910. The transaction processing terminal preferably includes a computer 910 and point-of-sale processing equipment, such as a credit card (i.e., magnetic card) reader 900, receipt printer 925 and communication equipment, such as a dial-up modem 935 and/or network connection, to facilitate on-line credit card validation and processing. The transaction terminal is preferably communicatively connected to a network, such as a local area network (LAN) 940, to facilitate communication with other terminals. Those skilled in the art will appreciate that the LAN may be a wired or wireless network, and may be a network configured other than as a LAN, such as a wide area network (WAN) or a virtual private network (VPN) without departing from the scope of the present invention. In addition to generating bills and processing payment, the transaction terminal may be used for seating administration and other purposes, in which case the transaction terminal may also be referred to as a seating/transaction terminal, a seating terminal or the like. Alternatively, seating administration may be performed using another terminal dedicated to seating administration or used for several purposes. Furthermore, a plurality of terminals may be provided to perform transaction processing and/or seating administration, depending upon the needs of a business.

A system in accordance with an exemplary embodiment of the present invention may also include one or more on-site guest terminals 980. The guest terminal 980 may allow a patron to input and review information (e.g., a reservation, a seating request, personal information, payment information or an order). It may take the form of a conventional personal computer or kiosk. It may also take the form of a personal digital assistant. It is communicatively connected to the local area network 940 to enable communication with other system terminals. Guests may input information on-site, such as while waiting, using one or more guest terminals. Furthermore, in the case of personal digital assistants, for example, the terminals may be used to provide entertainment (e.g., games, news and/or Internet access) while guests wait to be seated and to alert a guest when a table is ready.

Guests may also input and review information remotely via a network connection, such as via the Internet 945. Thus, for example, a guest may make a reservation from any computer with Internet connectivity 990, such as a home computer, office computer, or an Internet-enabled personal digital assistant or telephone.

A management terminal preferably includes a computer 920 and printer 930 for producing reports. The terminal is preferably communicatively connected to a network, such as a local area network 940, to facilitate communication with other terminals. In addition to generating management reports, the management terminal may be used for system administration and other purposes. Data for the reports may be maintained locally and/or on a remote data storage device 960. Report forms and related software may be stored on the management terminal and/or a server 950. A plurality of management terminals may be provided to perform management and administration functions, depending upon the needs of a business.

A service personnel (e.g., waiter/waitress) terminal preferably includes a portable personal digital assistant 970 equipped with wireless network connectivity. Wireless connectivity may be provided using a wireless transceiver built into the terminal or integrated into a peripheral, such as a removable PCMCIA or CompactFlash card or an external pack. A wireless access point 955 receives and transmits data to wireless transceivers and provides connectivity to the LAN 940. In lieu of wireless network connectivity, though far less convenient, server terminals may be periodically connected to the LAN 940 via wired connection, such as a Ethernet connectivity or connectivity through a cradle that is wired to another terminal for synchronization. Input, such as order information, may be entered into a server terminal in a conventional manner, such as by using a stylus and touch sensitive screen. Additional input means may include a portable magnetic card reader, such as an ActiveChecker™ CompactFlash magnetic card reader by BE Interactive Co. Ltd. www.beinteractive.co.kr) of Seoul Korea.

A kitchen terminal 915 includes a monitor (preferably a large monitor) to display pending order information. An input means, such as a keyboard, pointing device, or touch sensitive monitor, is included to allow kitchen personnel to conveniently update order status information, such as when an order is complete and ready for pickup or to indicate when a menu item is no longer available. The kitchen terminal is communicatively connected to the network 940 to facilitate communication with other terminals, including waitress terminals. Depending upon the needs of a business, a kitchen may include a plurality of kitchen terminals.

A server computer 915 may provide server computer functions, including database management, application hosting, web server functions, telephone application program interface functions, backup, storage, and network connectivity. In a preferred implementation, the server computer is communicatively connected to the network 940 to facilitate communication with other terminals, including waitress terminals. Depending upon the needs of a business, a plurality of server computers may be provided.

A preferred implementation of the present invention includes a reservation process 820, table assignment and release processes 830, 870, a telephony process, a live menu process 840, an order-taking process 850, a reporting process, a kitchen process 860 and a payment process 870. Each process is a methodology comprised of a sequence of steps, suitable for performance using a system as described above. The processes may be implemented using hardware, software and/or firmware such as a programmed computer. In the case of a software-implemented process, the software may be a stand-alone application, subroutine, subprogram, object file, dynamic link library or any other software manifestation or functional component thereof (each a “module”). Each process may be implemented using one or several modules, or a plurality of processes may be implemented using one module. In the latter case, the module may be referred to by various names based upon the various processes performed by the module. As used herein, the terms reservation module, table assignment module, table release modules, telephony module, live menu module, order module, reporting module, kitchen module and payment module refer to implementations of the processes using hardware, software and/or firmware including any combination thereof.

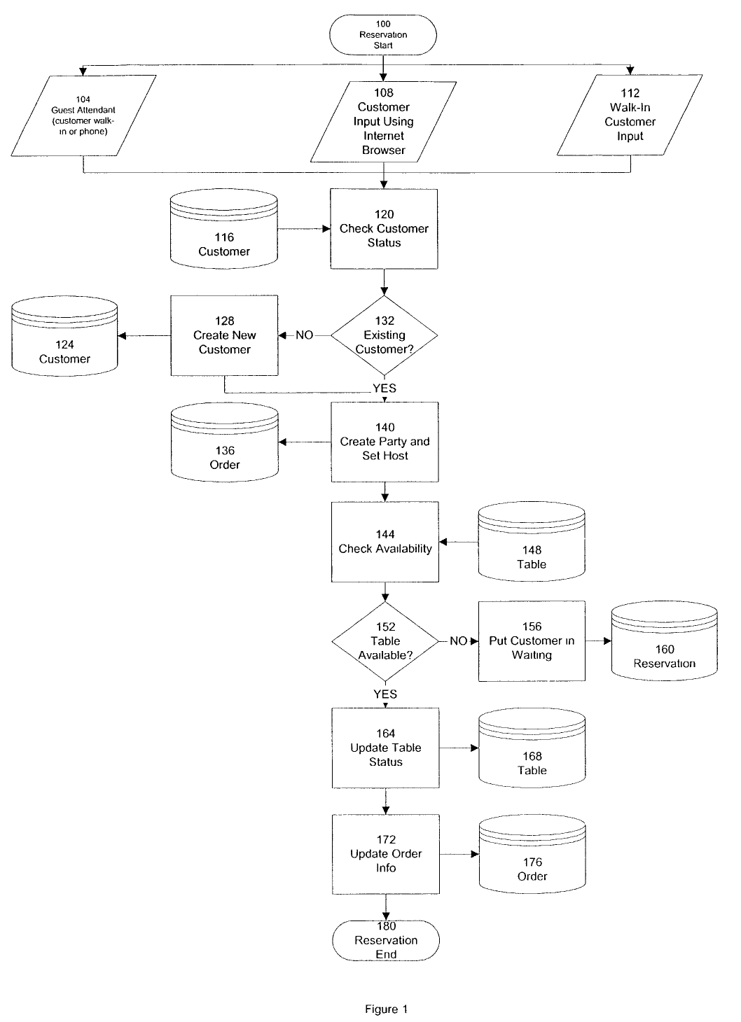

Referring now to FIG. 1, a flow chart for an exemplary reservation process is provided. The reservation process is preferably implemented using a reservation module. Reservation input may be provided by an attendant 104 such as a hostess or a maitre d'hotel, or by a customer via an on-site guest terminal 108 or remotely via the Internet 112. The present invention utilizes historical customer-specific information to provide enhanced customer service. Thus, the customer's status is checked to determine whether the customer is a new or existing customer 116-132. If the customer is a new customer, then a new customer record is created 124-128. The record may include, a name, address, telephone number, email address, telefacsimile number and the like. If the customer 15 is an existing customer, processing continues 132.

Next, a record for a party for the reservation is created 136-140. The party record may include a name for the party, the date and time for the reservation, the number of adults and children in the party, whether seating in a smoking or non-smoking section is desired, and the like.

Next, availability of a table is determined 144. A database including information pertaining to availability of tables is searched for an available table that meets the needs of the party 152. A single table or combination of tables (such as adjacent tables) may provide adequate seating. If a table is available, it is assigned to the party and the table status is updated for the reserved date and time, of course allowing a sufficient time for the party to complete a meal 164, 168. The table reservation is preferably retained for historical reference. In addition, party information may be entered in an order database 172, 176. However, if a table is not available, the customer's request may be placed in waiting (such as in a waiting queue) for a table to become available 156 on a desired date and time.

An advantage of a system and method in accordance with the present invention is the expansion of the reservation process. Reservations may be made in a conventional manner, using a customer terminal or remotely via a website, making it easier for the customer to reserve a table. Additionally, the reservation process is conducive to entry of order information, payment information, live menu information, and the like, which may be used to enhance the patron's dining experience and eliminate delays.

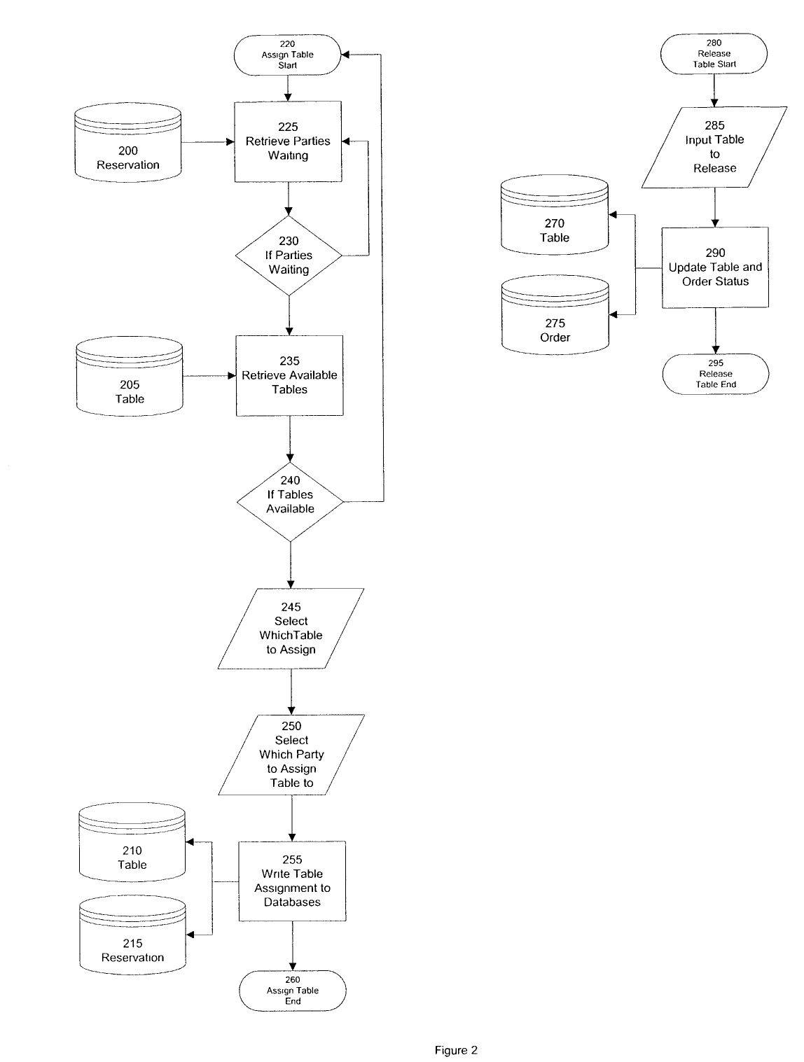

Referring to FIG. 2, an exemplary table management (assignment and release) process assigns and releases tables for seating. The table assignment and release processes are preferably implemented using a table management module or a table assignment module and release module. The assignment process entails retrieving information concerning the party, including the number of adults and children in the party, whether seating in a smoking or non-smoking section is desired, and the like. The information may be retrieved from waiting parties 225 or from a database 200 that includes information pertaining to reservations, as described above, so as to not assign a table when reserved. A database including information pertaining to availability of tables is searched for an available table that meets the needs of the party 205. If a plurality of tables are available, then a suitable table is selected. The selection may be made based upon customer preferences, waiter/waitress availability and/or other criteria 245, 250. If a plurality of parties are waiting for tables, then as a suitable table becomes available, it is assigned to a waiting party. The selection of which party to assign to the table may be made according to a waiting queue (first-in first-out), or other table assignment criteria 250. Upon assignment to a party having a reservation or waiting, the table status is updated 255, 210. In the case of a reservation, the reservation status may also be updated 255, 215.

An exemplary table release process makes a table available for reassignment. When a party leaves, a table identification is entered for release 285. The table status 270, 290 is updated to reflect that the table is now available for assignment to another party. The order status is also updated to reflect that the party has completed dining 275, 290.

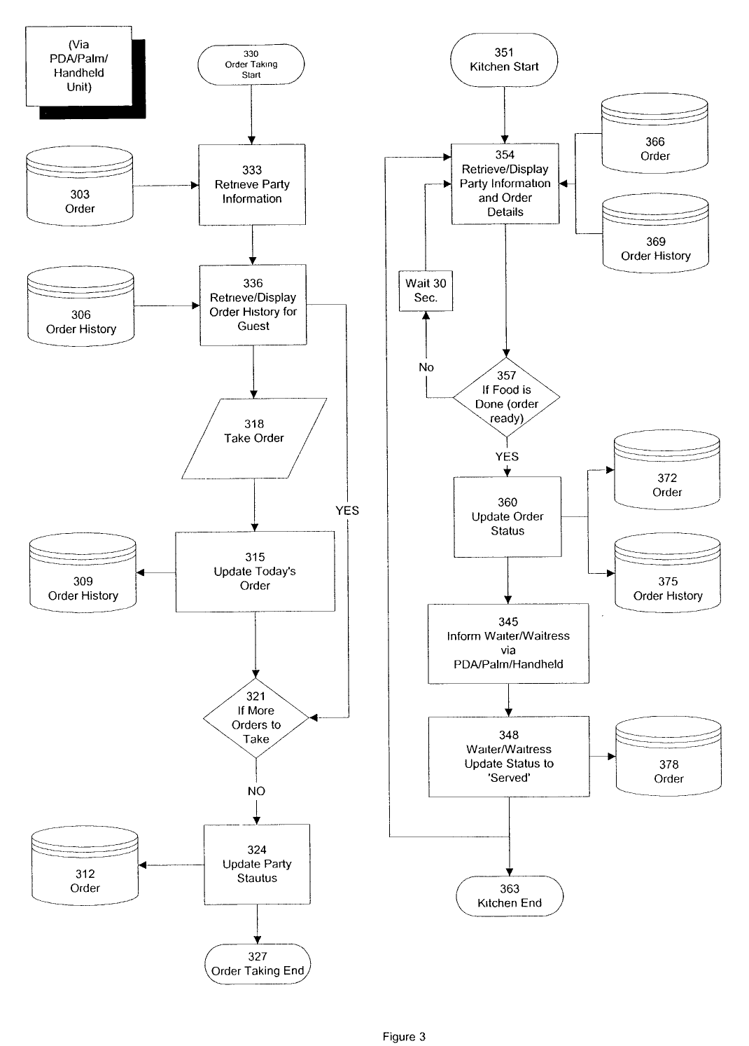

Referring now to FIG. 3, a flow chart for an exemplary order process is provided. The order process is preferably implemented using a order module. Party information is retrieved from an order database, as entered during the table assignment and/or reservation processes 303, 333. Order history information may also be retrieved 306, 366, revealing a guest's prior orders. This enables a guest to use a previous order as a reference point for a current order. Thus, for example, a guest may order the same steak entree that he had during his last visit, except that he may request that his steak be cooked slightly longer. An order is taken 318, preferably using a personal digital assistant or handheld computer with wireless connectivity, as described above. Next, the order history is updated with the current order information 309, 315. The order taking steps 306, 309, and 318-321 are repeated for each guest in the party. The current order information is also placed in a current order database.

Order information is used in an exemplary kitchen process for order fulfillment. The kitchen process is preferably implemented using a kitchen module. Order details are retrieved and displayed according to a party 354. Ordered items are prepared by kitchen staff. When an item is completed, the order status is updated 360, such as by user entry in the kitchen terminal of a signal representative of an “item complete” status. The signal is then sent from the kitchen terminal 915, to the network 940, to the wireless access point 955, to the personal digital assistant of the waiter/waitress 970. The waiter/waitress may then serve the item and update the status of the order to indicate that the item has been served 348, 378.

A warning may be provided to kitchen staff, a waiter/waitress and/or other personnel if an ordered item has not been prepared and/or served within a determined period of time, e.g., 30 minutes. This allows appropriate remedial action to be taken, such as prioritizing the ordered item and offering an apology and possibly a concession (e.g., a discount or free desert) to the inconvenienced guest.

A warning may also be provided to a waiter/waitress if an ordered item is unavailable. For example, if a guest orders a fish entree, while the kitchen has just completed another order using the last available piece of fish for the entree, the kitchen staff can promptly send an “unavailable” warning to the waiter/waitress. Again, this allows appropriate remedial action to be taken, such as offering an apology, suggesting an alternative item, prioritizing the new ordered item and possibly offering a concession (e.g., a discount or free desert) to the inconvenienced guest.

An advantage of a system and method in accordance with the present invention is the improvement of the order process. Orders are placed quickly and accurately via a portable waiter/waitress terminal with wireless connectivity. Item unavailability and order status information may be updated in real-time to enable the prompt processing of orders and remedial actions if necessary. Additionally, orders may be based upon historical order information to enhance the customer's dining experience. Not only does the foregoing facilitate ordering, but it is believed to significantly improve customer relationships by providing patron recognition, an historical baseline for a consistent or improved dining experience, and another reason for that patron to return.

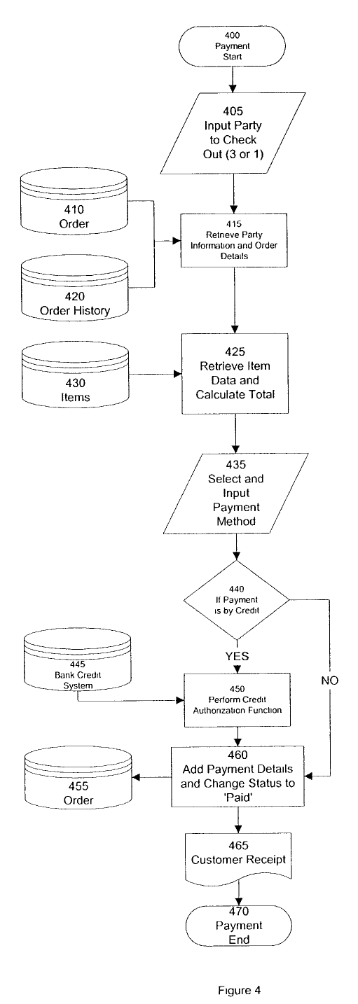

Order information is also used in an exemplary payment process for billing. The payment process is preferably implemented using a payment module. Referring now to FIG. 4, party information 405 and order details 410-420 are retrieved for billing. Item data (such as billing descriptions and prices) are also retrieved for each item that was ordered and served 425. Data pertaining to any applicable special discounts are also retrieved. The total is computed based on the foregoing data. Next, a method of payment is selected 435. The selection may be made using the transaction processing terminal 910 or the waiter/waitress terminal 970. If payment is by credit card, the credit card information is either entered for credit authorization and processing 450 or retrieved from a secure data source on the system. Personal identification or a password (which may be entered by the patron or server on the waiter/waitress terminal) may be required to access the stored credit card information. If entry is necessary, such information is preferably entered using a magnetic card (stripe) reader provided at the transaction processing terminal 910 or with the waiter/waitress terminal 970. Credit authorization and processing 450 preferably is accomplished using online access (e.g., dial-up access 905, 935) to a bank credit system 445 via a transaction terminal 910. A signature for credit card charges may be obtained in a conventional manner on a printed receipt, or using the waiter/waitress terminal 970 with a signature entry screen and stylus.

If payment is by check card or debit card, the card information may be entered for credit authorization and processing 450, again, preferably using a magnetic card (stripe) reader provided at the transaction processing terminal 910 or with the waiter/waitress terminal 970. An authorization code may be entered by the customer at the table using the waiter/waitress terminal 970, for example with a numeric code entry screen. Payment processing 450 preferably is accomplished using online access (e.g., dial-up access 905, 935) to a bank credit system 445 via a transaction terminal 910.

Upon processing payment, the order status is updated to paid and a customer receipt is generated. The receipt may be provided in printed and/or electronic form, provided to the customer in person and/or via email to the customer's email account. Emailed receipts may greatly facilitate the tracking of expenses and preparation of expense reports for business purposes. The receipt format may be subject to the customer's preferences and/or be compatible for use with various software applications, e.g., spreadsheet, viewer or financial management applications. Printed receipts may be generated at the transaction processing terminal 910 using a receipt printer 925, or with the waiter/waitress terminal 970 using a portable receipt printer.

Significantly, an electronic receipt may include a reply form for receiving patron feedback. To illustrate, a receipt may be emailed to a patron. The email may include a customer satisfaction form that may be completed by the patron and returned to the restaurant, such as by a reply email. The form may present a plurality of topics (e.g., the reservation, the table assignment process, the ordering process, the food quality, the food service, the payment process, etc. . . . ) for the patron to express his or her level of satisfaction or dissatisfaction (e.g., extremely satisfied, satisfied, mildly dissatisfied, extremely dissatisfied) and a place for entering specific comments. The customer satisfaction information may be used to improve services. To encourage a patron to complete and return the form, the restaurant may offer a discount or other incentive (e.g., two free deserts) for the patron's next visit. Information pertaining to an applicable discount or other incentive may be stored in the system and associated with the customer's information for application during a future visit.

As an alternative, the electronic receipt may include a link to an online form for receiving patron feedback. However, if accessing, completing and submitting such a form entails complexity or requires more effort, then it may be less effective.

An advantage of a system and method in accordance with the present invention is the improvement of payment processes. The portable waiter/waitress terminals make it feasible to process credit card and debit card payments at the table, if the terminals are equipped with card information entry means, such as a magnetic card reader. The system also enables use of credit card information stored from a previous visit, thus avoiding the hassle and delays of re-entering credit card information for each visit. Additionally, a system in accordance with the present invention may offer receipts in a determined format to facilitate a customer's record-keeping and expense form processing. Moreover, an electronic receipt may include a form to facilitate routinely gathering customer feedback.

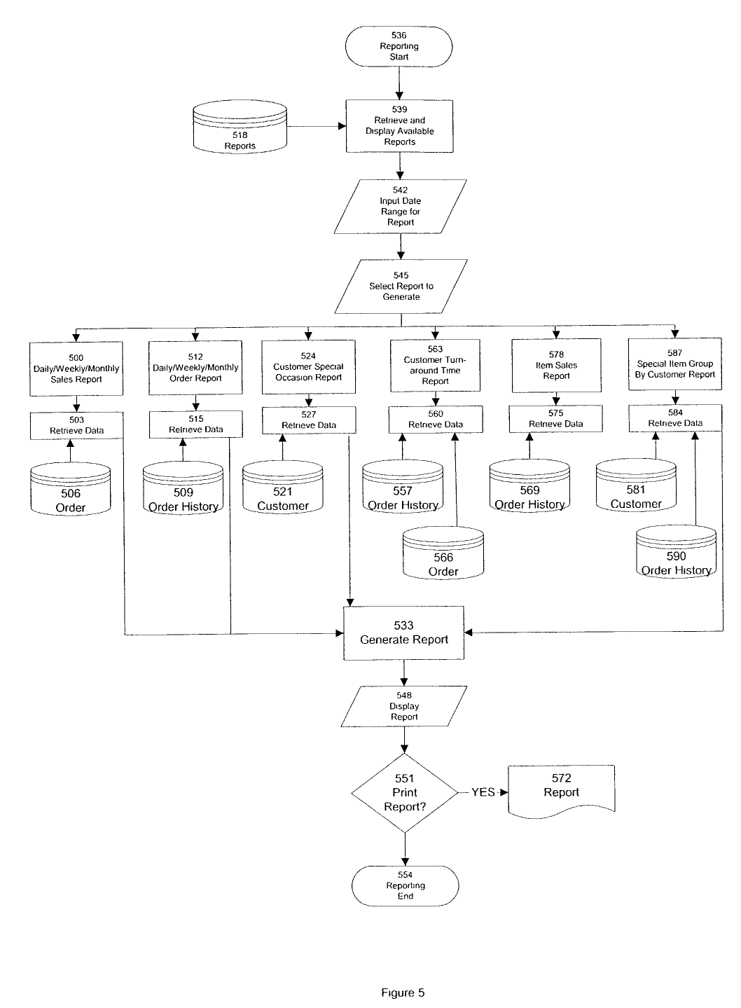

Referring to FIG. 5, an exemplary reporting process in accordance with the present invention produces management reports from stored data. The reporting process is preferably implemented using a reporting module. The process entails selecting an available report to produce 518, 539, 545, specifying a range of data 542, retrieving data within the specified range for the report, producing 533, displaying 548 and printing 551,572 the report if desired. For illustrative purposes, the reports may include sales 500, order 512, special occasion 524, turnaround time 563, item sales 578 and special item group 587 reports. Other reports may include customer satisfaction reports and reports for gauging personnel performance. Data for the reports may be stored in a plurality of data sources or a single data source. The data may be supplied to the data sources during the reservation process, table assignment process, table release process, messaging process, live menu process, order-taking process, kitchen process and/or payment process.

Selected report information may be made available to restaurant personnel (e.g., waiters and waitresses) via a terminal (e.g., a server terminal) to enable the personnel to gauge their own performance (e.g., in terms of sales and/or turnaround times), the popularity of certain menu items, and the like. For example, customer satisfaction results may be provided in reports to personnel enabling them to concentrate on improving service in critical areas.

An advantage of a system and method in accordance with the present invention is that the reports may include historical customer-specific information. This information may be used to develop targeted marketing and improve the quality of services. The system thus facilitates initiatives to improve service and expand business, by going well beyond maintenance and use of routine sales totals and statistics used by conventional restaurant management systems.

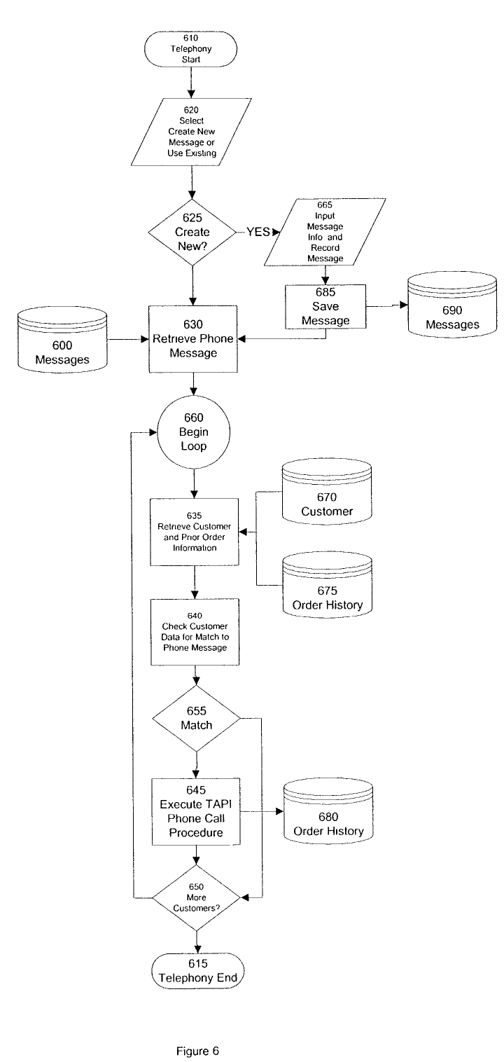

Referring now to FIG. 6, an exemplary messaging process in accordance with the present invention enables the production of voice and/or textual messages for delivery to selected patrons. It may be implemented using a messaging module. The process entails steps of creating or selecting a desired message 620, 625, defining customer criteria for target recipients of the message 665, identifying customers that satisfy the criteria 640, retrieving customer information for those customers 635, and delivering the message 645, 650.

An audio (e.g., voice) message, such as a .wav or .mp3 file, may be created in a conventional manner 665. An existing message may be retrieved from a data source 630. Alternatively or additionally, without departing from the scope of the present invention, a textual message (such as an electronic mail message) may be created or an existing text message may be retrieved. The message may, for example, be a reminder of an approaching reservation, a thank you for recent patronage, a congratulatory message (perhaps also offering a special discount) for a birthday or anniversary, a holiday greetings message, or a promotional message intended to attract new or repeat business. Messages may be stored in a conventional manner for reference and use at a later time.

Customer criteria for target recipients may defined on an ad hoc basis, or according to the message. To illustrate, a happy birthday message may be targeted to customers having a birthday near the date the message will be sent. In such case, the criteria may be a birth date within a defined period of time from the message date. This criteria may be manually input or established as a rule (instruction) in the system to automate the delivery of a birthday message to all customers having a birthday within a defined period of time of the message date (e.g., one week or one month). As another illustration, a promotional message highlighting a special on lobster may be sent to all customers who have ordered shellfish within the past year. In such case, the criteria may be an order within a defined period of time. Those skilled in the art will appreciate that the criteria may be based upon any customer information (e.g., personal information such as a name, address, birth date, anniversary; prior orders; payment information; or reservation information) stored in the system. Customers who do not wish to receive such messages, may opt out. As an incentive to accept the messages, the restaurant may promise to periodically send messages with special offers.

An important advantage of a system and method in accordance with the present invention is that the message (i.e., audio and/or text message) process may help market the restaurant, develop new business and strengthen existing customer relationships in a highly efficient manner. Many people greatly appreciate special attention such as a gentle reminder, a sincere thank you, a pleasant holiday greeting or some other pleasant message. Special offers will entice customers. Thus, the message (i.e., audio and/or text message) process and module provide an important marketing tool as an integral part of the system and method.

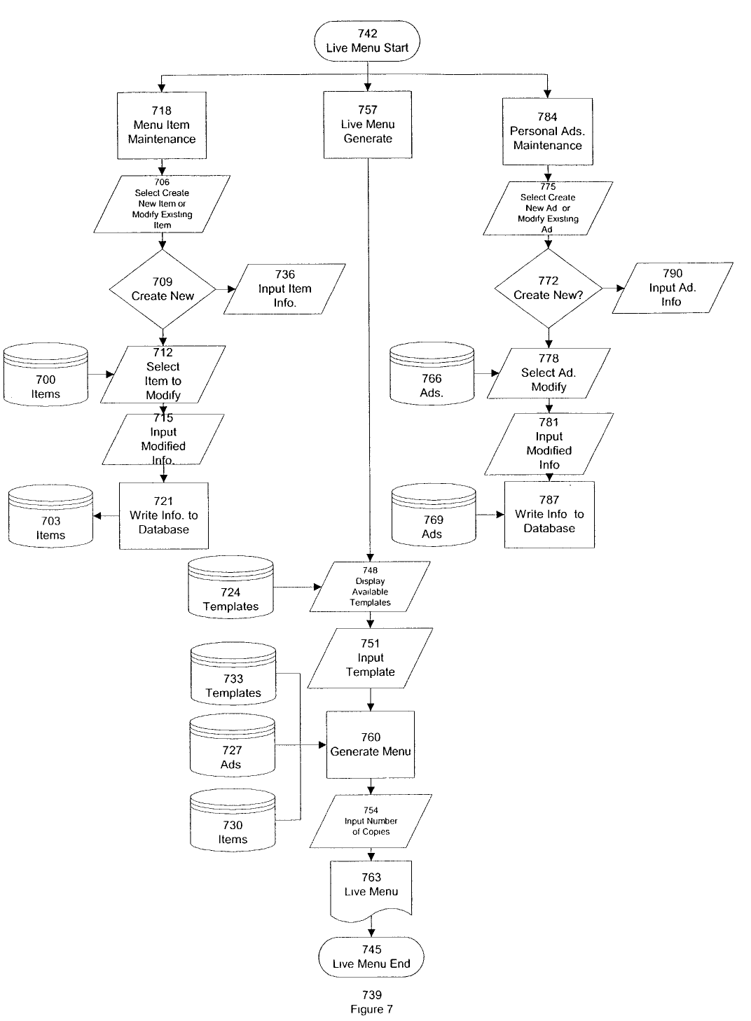

Referring now to FIG. 7, a live menu process in accordance with the present invention enables the production of up-to-date customized menus that may display messages, such as personal messages or advertisements. The process, which may be implemented using a live menu module, entails steps of menu item maintenance 700-721, 736, message (i.e., personal ad) maintenance 766-790, and production 724-230, 745-763.

Menu item maintenance 718 entails determining items for the menu. Available items may be retrieved from a data source or entered 706, 709. Retrieved items may be modified 712, 715. When input and retrieved items are ready for posting to a menu they may be written 721 to a data source 703. Items may be entered and selected on an ad hoc basis or according to availability, popularity, profitability, seasonal factors, the preferences of patrons having reservations and/or other criteria.

Message (i.e., personal ad) maintenance 766-790 entails message creation and retrieval, modification and writing to a data source for use with the live menu. A message such as a congratulatory message for a birthday, anniversary or some other special occasion; a personal advertisement or some other form of promotional message may be created in a conventional manner 775. Existing messages may be retrieved from a data source 766 and modified 778, 781 as desired. When input and retrieved messages are ready for posting to a menu they may be written 787 to a data source 769. While FIG. 7 refers to “personal ads” for purposes of illustrating an exemplary implementation, those skilled in the art will appreciate that the “personal ads” may be any type of message, comprised of graphics, photographs and/or text.

Menu production entails selecting a template for the menu 724, 751, and using the template 733 along with the stored item information 730 and message information 727 to create a live menu. Each template may be one or more blank sheets or a pre-formatted form menu. Preferably, the live menus are printed for distribution to patrons. 763.

Live menus may be produced periodically (e.g., daily, weekly, biweekly or monthly), on an ad hoc basis, for a holiday or special event, for a party prior to seating, or on some other basis. Printed live menus may be laminated, or inserted in folders or binders, depending upon the preferences of a restaurant.

An important advantage of a system and method in accordance with the present invention is that the live menu process accommodates special events. A tasteful congratulatory message may also enhance a customer's dining experience. In addition, the live menu process distinguishes a restaurant from other impersonal restaurants, and may strengthen existing customer relationships in a highly efficient manner. Moreover, messages (especially business advertisements) may provide a source of revenue to offset menu costs.

Those skilled in the art will appreciate that the various data sources conceptually illustrated in the flowcharts may be combined into one or a plurality of data sources. They are shown as separate units to keep the flowcharts simple and easy to follow. While the invention has been described in terms of its preferred embodiments, those skilled in the art will recognize that the invention can be practiced with modifications within the spirit and scope of the foregoing detailed description. Such alternative embodiments and implementations are intended to come within the scope of the present invention.

Having thus described the invention, what I claim as new and desire to secure by Letters Patent is as follows:

1. A system for managing a restaurant and enhancing patron service, said system comprising a plurality of terminals communicatively connected via a network, a wireless access point communicatively connected to said network, a plurality of modules, at least one portable terminal, said at least one portable terminal having wireless connectivity means for communicating with said wireless access point, and an historical data source accessible via said network, said historical data source being capable of storing data representative of customers and prior orders by customers.

2. A system for managing a restaurant and enhancing patron service as in claim 1, said plurality of terminals including at least one transaction processing terminal.

3. A system for managing a restaurant and enhancing patron service as in claim 1, said plurality of terminals including at least one kitchen terminal.

4. A system for managing a restaurant and enhancing patron service as in claim 1, said plurality of terminals including at least one management terminal.

5. A system for managing a restaurant and enhancing patron service as in claim 1, said plurality of terminals including at least one computer server terminal.

6. A system for managing a restaurant and enhancing patron service as in claim 1 said at least one portable terminal being a personal digital assistant.

7. A system for managing a restaurant and enhancing patron service as in claim 1, said plurality of terminals including at least one on-site guest terminal.

8. A system for managing a restaurant and enhancing patron service as in claim 1, said plurality of modules including at least one payment module.

9. A system for managing a restaurant and enhancing patron service as in claim 1, said plurality of modules including at least one reporting module.

10. A system for managing a restaurant and enhancing patron service as in claim 1, said plurality of modules including at least one messaging module.

11. A system for managing a restaurant and enhancing patron service as in claim 1, said plurality of modules including at least one ordering module.

12. A system for managing a restaurant and enhancing patron service as in claim 1, said plurality of modules including at least one live menu module.

13. A system for managing a restaurant and enhancing patron service as in claim 1, said plurality of modules including at least one reservation module.

14. A system for managing a restaurant and enhancing patron service as in claim 1, said plurality of modules including at least one table module for assigning and releasing tables.

15. A system for managing a restaurant and enhancing patron service as in claim 1, said plurality of modules including at least one kitchen module for assigning and releasing tables.

16. A system for managing a restaurant and enhancing patron service, said system comprising a plurality of terminals communicatively connected via a network, a wireless access point communicatively connected to said network, a plurality of modules, at least one portable terminal, said at least one portable terminal being a personal digital assistant and having wireless connectivity means for communicating with said wireless access point, and an historical data source accessible via said network, said historical data source being capable of storing data representative of customers and prior orders by customers, said plurality of terminals including:
at least one transaction processing terminal,
at least one kitchen terminal,
at least one management terminal,
at least one computer server terminal, and
at least one on-site guest terminal.

17. A system for managing a restaurant and enhancing patron service as in claim 16, said plurality of modules including at least one payment module, at least one reporting module, at least one messaging module, at least one ordering module, at least one live menu module, at least one reservation module, at least one table module for assigning and releasing tables, and at least one kitchen module.

18. A method for managing a restaurant and enhancing patron service using a system according to claim 17, said method including steps of
receiving a reservation from a patron, said reservation including patron information, a request for a table on a determined date and at a determined time; and
determining whether said patron desires a message in a live menu, and if said patron desires a message in the live menu, then saving the message for inclusion in the live menu.

19. A method for managing a restaurant and enhancing patron service as in claim 18, said method further including steps of
assigning a table based upon said reservation,
providing a live menu to the patron,
taking an order for one or more menu items using a portable terminal,
communicating said order to a transaction processing terminal and a kitchen terminal,
using the kitchen terminal, communicating a prepared status to the portable terminal when said order is prepared,
processing payment using the transaction terminal, and
releasing the table.

20. A method for managing a restaurant and enhancing patron service as in claim 18, said method further including steps of
determining a message for delivery to the patron according to said patron information,
delivering said message to the patron.
